(19) United States
(12) Patent Application Publication
(10) Pub. No.: US 2008/0299819 A1
(43) Pub. Date: Dec. 4, 2008

(54) CONNECTION DETECTION DEVICE

(75) Inventor: Toshifumi Kakutani, Toride-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/128,369

(22) Filed: May 28, 2008

(30) Foreign Application Priority Data
May 30, 2007 (JP) 2007-143847

(51) Int. Cl. H01R 3/00

(52) U.S. Cl. 439/489

(57) ABSTRACT

A connection detection device is mounted on an apparatus which has a circuit board with connectors and load circuits connected to the circuit board via each of the connectors. The connection detection device that detects a connection state between the circuit board and the load circuits includes a plurality of serial connection circuits in which pull-down resistors are connected in series with each of the connection detection signal lines wired to a predetermined contact of the connectors of the circuit board, wherein the pull-down resistors have different resistance values, a pull-up resistor connected to a parallel connection circuit in which the plurality of serial connection circuits are connected in parallel, a detection unit to detect voltage values of a connection point between the pull-up resistor and the parallel connection circuit, and a determination unit to determine the connection state between the circuit board and the load circuits by the detected voltage value.

### BACKGROUND OF THE INVENTION

1. Field of the Invention

The present invention relates to a connection detection device that detects the connection state between connectors.

2. Description of the Related Art

FIG. 8 illustrates a structure of a conventional connection detection device that detects the connection state between connectors. For example, a connector 501 is mounted on a control board 507 which is mounted on a housing of an image forming apparatus. A connector 505 is provided in a load 506 (including a circuit board) that is mounted on the housing. A connector 502 which is mounted at one end of a harness 503 is fitted to the connector 501, and a connector 504 which is mounted on the other end of the harness 503 is fitted to the connector 505. The control board 507 and the load 506 are in a state of being connected to each other via the harness 503.

On the harness 503, a signal line 503a is mounted. The signal line 503a transmits a signal (connection detection signal) that varies according to a connection state between connectors. The control board 507 includes a central processing unit (CPU) 508 to which a pattern (signal line) 509 on the circuit board which corresponds to one end of the signal line 503a is input. On the control board 507, one end of the signal line 509 to be input to a port of the CPU 508 is connected to a power source via a resistor r8 for pull-up. A low potential signal line 506a is wired to ground (earthed) in the load 506. The low potential signal line 506a is wired to the other end of the signal line 503a.

A connection detection device that has such a structure determines whether the connector connection (fitting) state is normal or abnormal depending whether a voltage of the signal line 509 input to the port of the CPU 508 is at a low (L) or a high (H) level.

FIG. 9 is a flow chart illustrating the connection detection operation procedures. When power is on in step S101, a power source voltage Vcc and a voltage of 0 V are respectively supplied to the control board 507 and the load 506. In step S102, the CPU 508 detects a voltage of the signal line 509 input to a port. When the connectors 502 and 504 are respectively connected to the connectors 501 and 505 in the voltage detection, the CPU 508 detects a voltage at the level L since the voltage of 0 V is applied to the signal line 509. Meanwhile, the CPU 508 detects a voltage at the H level since the power source voltage Vcc is applied to the signal line 509 when the connector 502 (or 504) is not connected to the connector 501 (or 505).

In step S103, the CPU 508 determines whether the voltage of the signal line 509 is at the H level or the L level. If a detected voltage is at the L level, the process ends. On the other hand, if the detected voltage is at the H level, the CPU 508 generates an alarm in step S104, and then the process ends. According to these operations, the connectors 502 and 504 are confirmed whether these respective connectors are correctly connected with the connectors 501 and 505.

FIG. 10 illustrates a structure of another conventional connection detection device. The harness 503 includes two signal lines 503a and 503b which transmit connection detection signals. Both terminals of the connector 505 are conducting at the load 506 side. Both terminals are connected to the two signal lines 503a and 503b. The pattern 509 on the board that is wired to the signal line 503a is input to a port of the CPU 508 on the control board 507 side, similar to that in FIG. 8. A pattern 519 that is wired to the signal line 503b is wired to ground (earthed). The connection detection signals are in a loop-back at the load 506 side as illustrated. Therefore, the connection state of even a connector that can be obliquely inserted, such as a flexible connector, can be positively detected. The connection detection operation is processed in the manner similar to FIG. 8 also in this case.

According to Japanese Unexamined Utility Model Application Laid-Open No. 05-84875, a conventional connection detection device is known that detects the abnormality of the connector connections in a case where even one module is unconnected among a plurality of the connected modules.

In the connection detection devices illustrated in FIGS. 8 to 10, the number of the necessary ports (pin numbers) increases as the number of the connectors increases since the devices need one port for each connector to input signals for connection detection.

While the connection detection device described in Japanese Unexamined Utility Model Application Laid-Open No. 05-84875 can obtain information that one of these connectors is unconnected, the device cannot specify which module is unconnected.

### SUMMARY OF THE INVENTION

The present invention is directed to a connection detection device that can detect connection states of a plurality of connectors by using a voltage of one signal for connection detection.

According to an aspect of the present invention, a connection detection device that is mounted on an apparatus includes a circuit board having a plurality of connectors and a plurality of load circuits to be connected to the circuit board via each of the plurality of the connectors, wherein the connection detection device detects a connection state between the circuit board and the plurality of the load circuits, a plurality of serial connection circuits in which a plurality of pull-down resistors are connected in series with each of connection detection signal lines which is wired to each predetermined contacts of the plurality of the connectors of the circuit board, wherein each of the plurality of the pull-down resistors has a different resistance value, a pull-up resistor connected to a parallel connection circuit in which the plurality of serial connection circuits are connected in parallel, a detection unit configured to detect a voltage value of a connection point between the pull-up resistor and the parallel connection circuit, and a determination unit configured to determine the connection state between the circuit board and the plurality of the load circuits according to the voltage value detected by the detection unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example circuit structure of a connection detection device according to a first exemplary embodiment of the present invention.

FIG. 2 briefly illustrates the circuit structure of the connection detection device illustrated in FIG. 1.

FIG. 3 is an example correspondence table illustrating a determination table for the connector connection state stored in a read-only memory (ROM).

FIG. 4 is a flow chart illustrating connection detection procedures according to the first exemplary embodiment.

FIG. 5 illustrates an example circuit structure of a connection detection device according to a second exemplary embodiment of the present invention.

FIG. 6 illustrates an example circuit structure of a connection detection device according to a third exemplary embodiment of the present invention.

FIG. 7 illustrates an example circuit structure of a connection detection device loaded to a control unit in an image forming apparatus according to a fourth exemplary embodiment of the present invention.

FIG. 8 illustrates a conventional connection detection device.

FIG. 9 is a flow chart illustrating conventional connection detection procedures.

FIG. 10 illustrates another conventional connection detection device.

### DETAILED DESCRIPTION OF THE EMBODIMENTS

Various exemplary embodiments, features, and aspects of the invention will be described in detail below with reference to the drawings.

### First Exemplary Embodiment

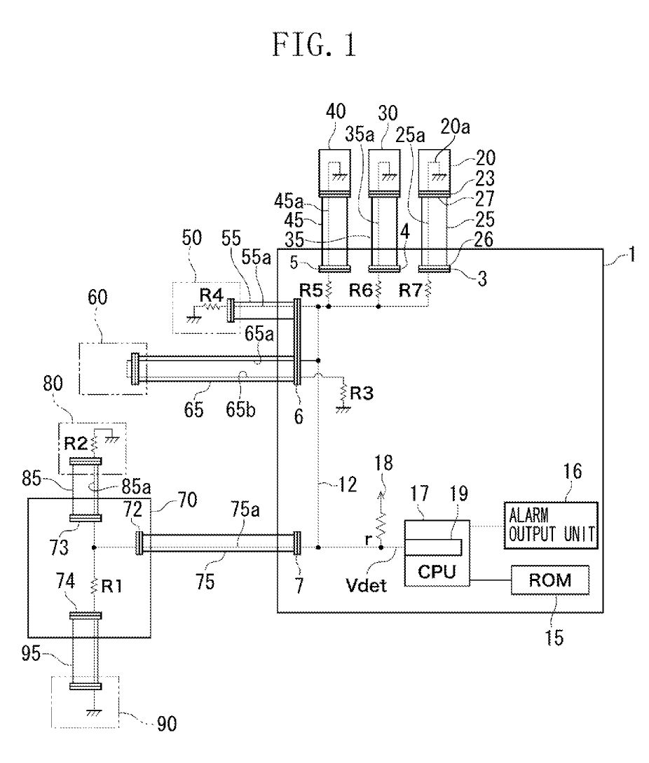

FIG. 1 illustrates a circuit structure of a connection detection device according to a first exemplary embodiment of the present invention. The connection detection device which is loaded to a control unit in an image forming apparatus detects a connector connection (fitting) state between a control board (circuit board) 1 controlling the image forming apparatus and a plurality of the load circuits (such as loads 20, 30, 40, 50, and 60 and a sub board 70). A CPU 17 is mounted on the control board 1. The CPU 17 has an analog-to-digital (A/D) port 19 through which analog signals are input. A ROM 15 and an alarm output unit 16 connected to the CPU 17 are also mounted on the control board 1. In the ROM 15, a detection operation program and a determination table for the connector connection state, as described below, are stored. The alarm output unit 16 generates an alarm sound in accordance with an instruction from the CPU 17.

Connectors 3 to 7 which respectively connect a plurality of loads as control objects are mounted (placed) on the control board 1. The control board 1 and each of the loads are respectively connected with harnesses 25, 35, 45, 55, 65 and 75 including a plurality of electric cables (signal lines) as coupling materials. For example, a connector 26 for electric cables is fitted to a connector 3 in the control board 1, and the connector 26 is mounted on one end of the harness 25 that connects the control board 1 with the load 20. A connector 27 for electric cables is fitted to a connector 23 mounted on the load 20, and the connector 27 is mounted on the other end of the harness 25. A connection detection signal line 25a that is wired to a predetermined contact of the connector 3 is mounted on the harness 25. The other loads and the control board 1 are also configured in the same manner.

As a load which is a control object, components such as a sensor, motor, a capacity load (CL), and a solenoid (SL) are used. In a case where a plurality of circuit boards are mounted, in addition to the sub board 70 other than the control board 1, various circuit boards according to applications and purposes of an apparatus and system, for example, a circuit board for detecting a toner bottle set in an image forming apparatus as described below, are also included as a load.

In the control board 1, pull-down resistors are mounted for each load, and the resistors are connected in series with connection detection signal lines which are included in the harnesses to be connected. The plurality of pull-down resistors is connected in series with each of connection detection signal lines and configures a plurality of serial connection circuits. The pull-down resistors have a different resistor value per load. More specifically, the connection detection signal line 25a included in the harness 25 is connected in series with a resistor R7 in the control board 1 that is wired to a terminal of the connector 26 for electric cables. The harness 25 is connected to the load 20. Among terminals of the connector 23 mounted on the load 20, a signal line (low potential signal line) 20a that is wired to a terminal of the connection detection signal line 25a is wired to ground (earthed). As to the loads 30 and 40, respective connection detection signal lines 35a and 45a that are included in the harnesses 35 and 45 are similarly connected to resistors R6 and R5 in the control board 1. The resistors R6 and R5 are wired to terminals of respective connectors for electric cables.

The resistors can be mounted on a load side as a control object instead of the side of the control board 1. For example, a resistor R4 in the load 50 is mounted between the connection detection signal line 55a included in the harness 55 and, the ground. Harnesses 85 and 75 are respectively mounted between a load 80 and the sub board 70, and between the sub board 70 and the control board 1. A resistor R2 in the load 80 is mounted between a connection detection signal line 85a included in the harness 85 and, the ground. As an example of a resistor provided in a load, a connection detection device can be mounted on a control board of a DC brushless motor. Further, a resistor R1 can be provided before the connector 74 which is mounted on the sub board 70 (i.e., a load), and connected to a harness 95 for a load 90.

A connection detection signal line 65a is looped back and connected to a connection detection signal line 65b at the return side. The connection detection signal line 65a is included in a harness 65 that is connected to a load 60. A resistor R3 is mounted between the connection detection signal line 65b and the ground on the control board 1. The resistor R3 can be mounted on the load 60 side instead of the control board 1 side.

Connection detection signal lines 25a, 35a, 45a, 55a, 65a and 75a are respectively wired to a signal line 12 on the control board 1 via terminals of connectors 3, 4, 5, 6, and 7. The signal line 12 on the control board 1 is connected to a power source 18 for pull-up via a pull-up resistor r. Detection voltage Vdet of the signal line 12 as a voltage detection signal line is input to the A/D port 19 of the CPU 17. The A/D port 19 incorporates an A/D converter, converts an input analog value into a digital value, and outputs the digital value. The CPU 17 determines a connector connection state based on the output digital value of the detection voltage Vdet.

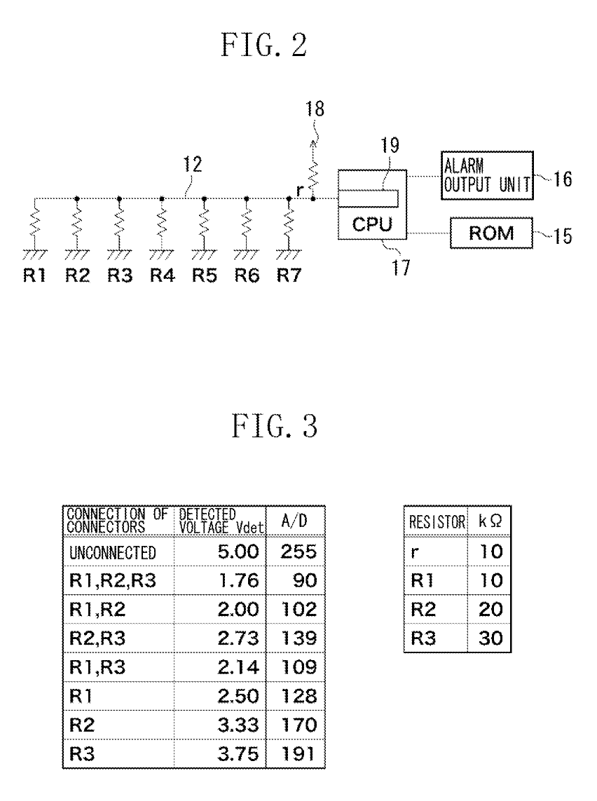

Although various manners are considered for mounting resistors as described above, a circuit structure including signal lines to which the resistors are connected can be simply described. FIG. 2 is a diagram simply illustrating a circuit structure of the connection detection device illustrated in FIG. 1. The circuit structure shows that the signal line 12 is connected to a parallel connection circuit in which resistors R1 to R7 are connected in parallel and is connected to the power source 18 with the pull-up resistor r. The signal line 12 (a connection point between the parallel connection circuit and the pull-up resistor r) is input to the A/D port 19 of the CPU 17. Although the present exemplary embodiment indicates the pull-down resistors R1 to R7, a number of the resistors is not limited.

Detection operation of a connection detection device having the above-described structure is specifically described. Resistors herein connected to the signal line 12 are three resisters R1, R2 and R3 for the simple description. In a case where all connectors are normally connected, the resistors, R1, R2, and R3 are all conducting in which a voltage of the power source 18 is defined as Vcc, the voltage Vdet appearing at the A/D port 19 is expressed in formula (1).

Vdet=R1×R2×R3×Vcc/{R1×R2×R3+rx(R1×R2+R2×R3+R1×R3)} (1)

In a case where the resistors R1 and R2 are conducting, but the resistor R3 is not conducting, the voltage Vdet appearing at the A/D port 19 is expressed in formula (2).

Vdet=R1×R2×Vcc/{R1'R2+rx(R1+R2)} (2)

The voltage Vdet appearing at the A/D port 19 can be obtained by changing only the value of the resistor in the formula similar to the formula (2) in cases where only the resistor R1 or only the resistor R2 is not conducting.

In cases where only the resistor R1 is conducting, but the resistors R2 and R3 are not conducting, the voltage Vdet appearing at the A/D port 19 is expressed in formula (3).

Vdet=R1×Vcc/(R1+r) (3)

The voltage Vdet appearing at the A/D port 19 can be obtained by changing only the value of the resistor in the formula similar to the formula (3) in cases where only the resistor R2 or only the resistor R3 is conducting.

In cases where all resistors are not conducting, it is Vdet=Vcc. In cases where at least one conduction detection signal lines is shorted out (short circuited) to the ground, it is Vcc=0V.

The A/D port 19 conducts analog-to-digital conversion of the input voltage Vdet with a resolution of 256 bits, and outputs a digital value. The CPU 17 refers to the determination table for connector connection state stored in the ROM 15 based on the digital value, and detects each of the connector connection states.

FIG. 3 is a correspondence table indicating a determination table for the connector connection state stored in the ROM 15. The determination table for the connector connection state illustrated in FIG. 3 indicates the connector connection states for the resistors R1, R2 and R3 while the states for other resistors are omitted. More specifically, the determination table for the connector connection state indicates corresponding relations of the connected connectors, detection voltage Vdet and A/D converted value. The table shows R1=10 kΩ, R2=20 kΩ, R3=30 kΩ, r=10 kΩ.

For example, in a case where the digital value of the detection voltage Vdet detected by the A/D port 19 is 139, a load allocated to the resistor R1 is unconnected. When the connector connection state is detected as unconnected, the CPU 17 generates an alarm sound using the alarm unit 16 and notifies to a user. Therefore, the user can immediately notice that the connector is not connected. Further, the audio pattern (e.g., rhythms and melody) of the generated alarm sound (audio) can be changed according to the types and combination of the unconnected connectors, in other words, according to the detected digital values. Thus, each distinctive audio pattern enables a user to immediately recognize which connector is not connected.

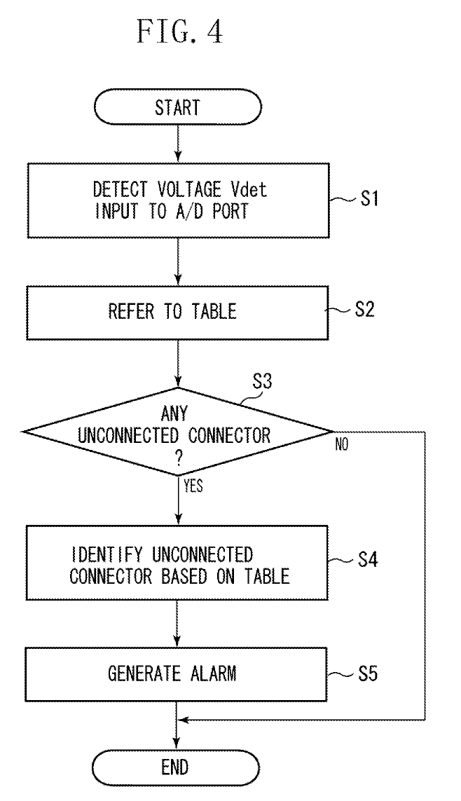

FIG. 4 is a flow chart indicating the connection detection procedures. The processing program is stored in the ROM 15. When the power source voltage Vcc is applied, the CPU 17 executes the program. First, in step S1, the CPU 17 detects the detection voltage Vdet input to an input pin of the A/D port 19. In step S2, the CPU 17 refers to the determination table for the connector connection state based on the detected detection voltage Vdet. In step S3, the CPU 17 determines presence of any unconnected connectors.

If no unconnected connectors are present (NO in step S3), the CPU 17 finishes the detecting operation. Meanwhile, in cases where any unconnected connectors are present (YES in step S3), the CPU 17 identifies the unconnected connector from the determination table for the connector connection state in step S4. In step S5, the CPU 17 generates an alarm sound in a sound pattern corresponding to the unconnected connector. Thereafter, the CPU 17 finishes the detection operation.

An indicator can be connected to the CPU 17. The CPU 17 can cause the ROM 15 to store relations between the digital values and the unconnected loads and the indicator can indicate which load is unconnected according to the detected digital values.

According to the first exemplary embodiment as described above, a plurality of connector connection states can be concurrently detected using one port. Therefore, the exemplary embodiment can facilitate a check of unconnected connectors at production lines and improve yield. Errors due to connection failure can be reduced. As a result, an efficiency of the production lines can be improved. Further, since one port can detect a plurality of connector connection states, a pattern formation on a circuit board becomes easier and not only a number of the ports necessary for detection but also manufacturing cost can be reduced.

In the above embodiment, the connector connections are performed on both the control board side and the load side of the harnesses. However, the harnesses can be connected by the connector on one side while the other side of the harnesses can be directly mounted on either the control board or the load. The same configuration can be applied to the embodiments as described below.

### Second Exemplary Embodiment

According to the first exemplary embodiment, a connection detection device includes a CPU mounted on a control board and its peripheral components. According to a second exemplary embodiment, a connection detection device includes a checker device having a power source independent from a control board. The checker device is used as an inspection device in a factory where certain products (i.e., image forming apparatuses in this case) are manufactured.

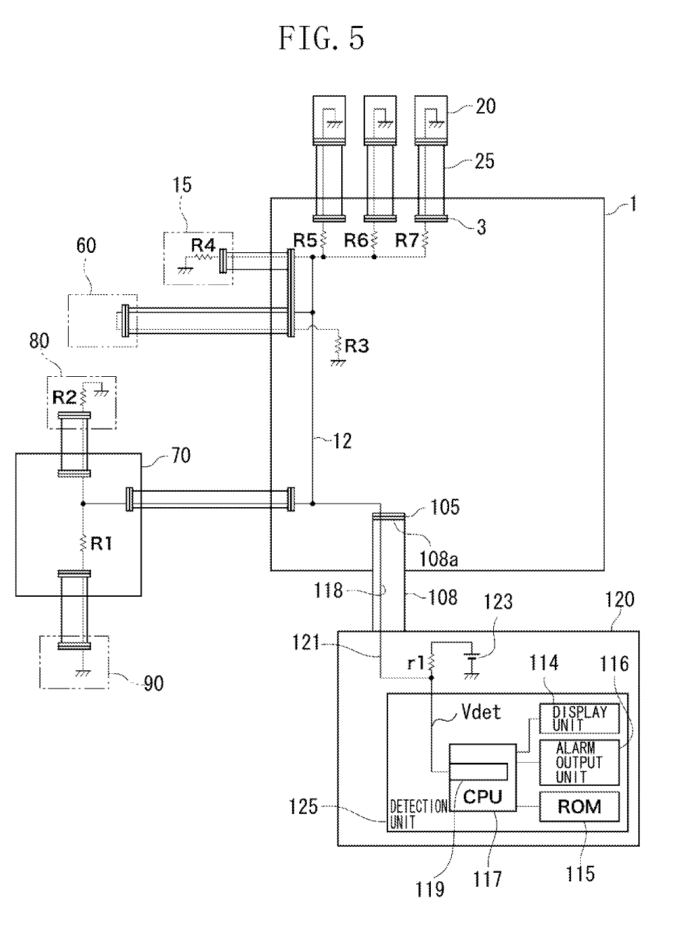

FIG. 5 illustrates a circuit structure of the connection detection device according to the second exemplary embodiment of the present invention. The components similar to those used in the first exemplary embodiment are denoted with same numerals and its description is not repeated. On the control board 1, instead of the CPU, a connector 105 for the checker device is mounted on the control board 1. A connector 108a for electric cables of a harness 108 is connected to the connector 105 for the checker device. The harness 108 is drawn from a checker device 120.

The checker device 120 has a detection unit 125 to which a connection detection signal line 121 is input and a power source 123 to which the signal line 121 is connected via a pull-up resistor r1. The detection unit 125 incorporates a CPU 117, a ROM 115, and an alarm output unit 116 which have the similar functions to the CPU 17, the ROM 15 and the alarm output unit 16 according to the first exemplary embodiment, and a display unit 114. In the CPU 117, an A/D port 119 is mounted similar to the first exemplary embodiment. In the ROM 115, a determination table for a connector connection state is stored similar to the first exemplary embodiment. The display unit 114 displays a connected/unconnected state per connector in accordance with the determination result of the connector connection state.

In the connection detection device having the above structure, a signal line 121 in the checker device 120, a connection detection signal line 118 included in the harness 108, and a signal line 12 formed in the control board 1 become conducting by connecting the connector 108a for electric cables to the connector 105 for the checker device. Therefore, a detection voltage Vdet is input to the A/D port 119, similar to the connection detection operation according to the first exemplary embodiment, in a state where the signal line 121 of the connection detection signal is connected to the power source 123 via the pull-up resistor r1.

When a connection state of each connector is detected, the CPU 117 generates an alarm sound using the alarm output unit 116, and concurrently displays each of the connector connection states on the display unit 114. Users can immediately know which connector is not connected from an alarm sound and a screen display.

As described above, the connection detection device according to the second exemplary embodiment utilizes an independent power source on the checker device side, so that the connector connection state can be detected even though it is in a state where a power source is not supplied to a connection detection object or the control board. In other words, a connector connection state can be detected even in a state where a power source of an image forming apparatus that mounts the control board is off. Furthermore, it is not necessary to consider a power source state of a product in order to increase the detection accuracy of A/D conversion, so that the power source can be freely changed.

### Third Exemplary Embodiment

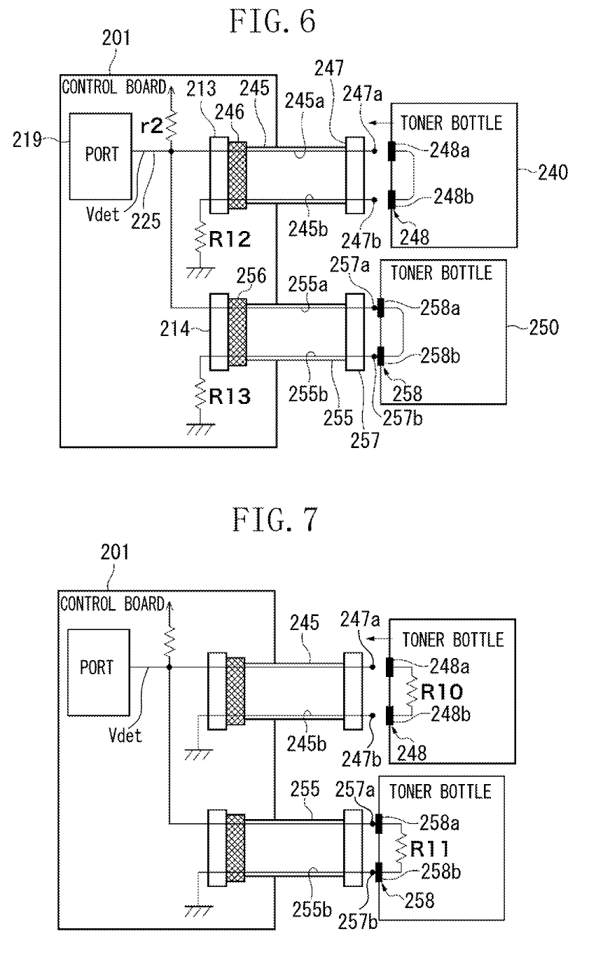

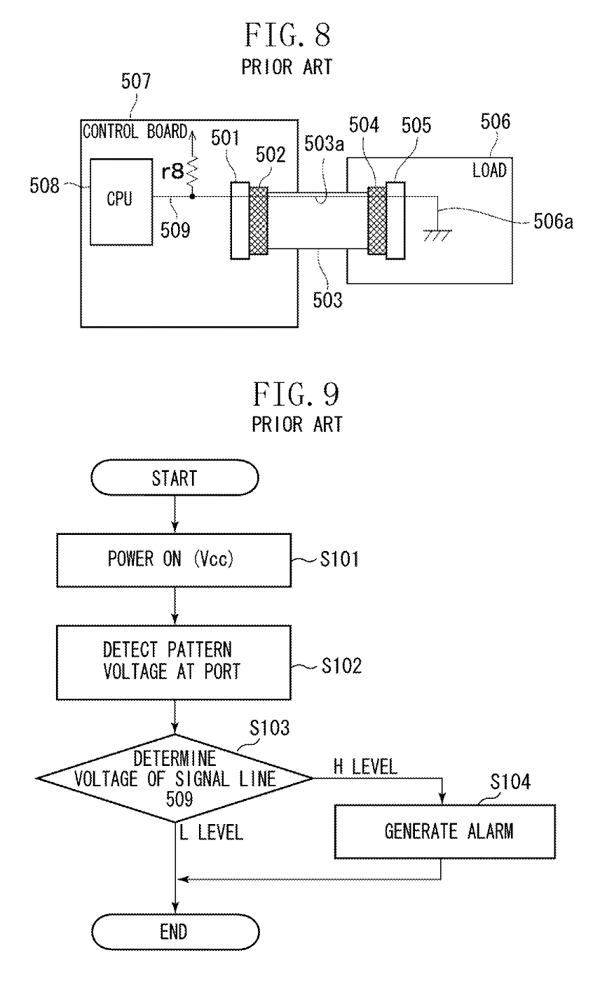

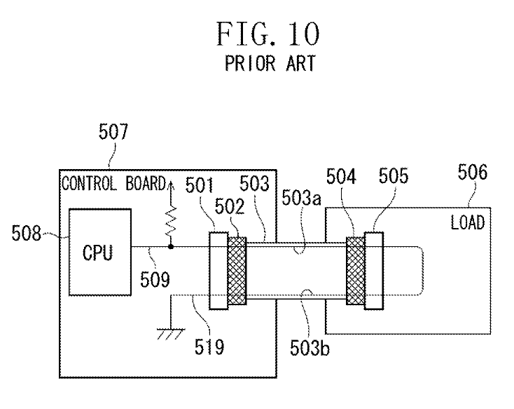

FIG. 6 is a circuit structure illustrating a connection detection device according to a third exemplary embodiment of the present invention. An image forming apparatus has a plurality of toner bottles and replenishes toners by replacing the toner bottles. The connection detection device is loaded to a control unit in the image forming apparatus, and detects a connector connection state between a control board 201 which controls the image forming apparatus and two toner bottles 240 and 250 which are connected to the control board.

The control board 201 and the toner bottle 240, and the control board 201 and the toner bottle 250 are respectively connected via harnesses 245 and 255. More specifically, connectors 213 and 214 for two toner bottles 240 and 250 are mounted on the control board 201. The connector 213 can be detachably attached to a connector 246 for electric cables. The connector 246 for electric cables is mounted on one end of the harness 245. A male type connector 247 for electric cables mounted on the other end of the harness 245 is detachable to a female type connector 248 mounted on the toner bottle 240. Similarly, the connector 214 can be detachably attached to a connector 256 for electric cables. The connector 256 is mounted on one end of the harness 255. A male connector 257 for electric cables mounted on the other end of the harness 255 can be detachably attached to a female connector 258 mounted on the toner bottle 250.

The harness 245 includes a pair of connection detection signal lines 245a and 245b. One end of the connection detection signal line 245a is connected to a signal line 225 in a state where the connector 246 for electric cables is fitted to the connector 213. The signal line 225 is input to an A/D port 219 on the control board 201. The other end of the connection detection single line 245a is connected to a pin 247a of the connector 247 for electric cables. One end of the connection detection signal line 245b is connected to the ground on the control board 201 via a pull-down resistor R12 in a state where the connector 246 for electric cables is fitted to the connector 213. The other end of the connection detection signal line 245b is connected to a pin 247b of the connector 247 for electric cables.

In the female connector 248, each of the pins 247a and 247b is inserted. Pin sockets 248a and 248b are short-circuited. FIG. 6 illustrates a state that the connector 247 for electric cables is detached from the female connector 248.

Similarly, the connector 214 can be detachably attached to the connector 256 for electric cables mounted on one end of the harness 255. A male connector 257 for electric cables can be detachably attached to a female connector 258. The male connector 257 is mounted on the other end of the harness 255 and the female connector 258 is provided in the toner bottle 250.

The harness 255 includes a pair of the connection detection signal lines 255a and 255b. One end of the connection detection signal line 255a is connected to the signal line 225 in a state where the connector 256 for electric cables is fitted to the connector 214. The signal line 225 is input to the A/D port 219 on the control board 201. The other end of the connection detection single line 255a is connected to a pin 257a of the connector 257 for electric cables. One end of the connection detection signal line 255b is connected to the ground on the control board 201 via a pull-down resistor R13 which has a different resistance value from the pull-down resistor R12 in a state where the connector 256 for electric cables is fitted to the connector 214. The other end of the connection detection signal line 255b is connected to a pin 257b of the connector 257 for electric cables.

In the female connector 258, pin sockets 258a and 258b are short-circuited. The pins 257a and 257b are respectively inserted to the pin sockets 258a and 258b. FIG. 6 illustrates a state that the connector 257 for electric cables is fitted to the female connector 258.

On the control board 201, the CPU (not illustrated) having the A/D port 219 is mounted. The signal line 225 is input to the CPU. On the control board 201, a ROM and an alarm output unit connected to the CPU are further mounted; however, they are omitted in FIG. 6. The signal line 225 is connected to the power source via a pull-up resistor r2.

The connection detection device having the above-described structure can detect connector connection states of the toner bottles 240 and 250 by conducting connection detection operation similar to the first exemplary embodiment. The connection detection device can easily determine where a toner bottle is set (or not set) when the function of looping back connection detection signals is provided to the connection detection device and different resistance values are set to the resistors R12 and R13. Therefore, workability in connecting toner bottles can be improved. The toner bottles are replacement parts in the image forming apparatus. A toner bottle structure can be simplified by mounting resistors on the control board side.

In cases where a plurality of the toner bottles is formed almost in the similar shape, the setting error of the toner bottles may occur. In such a case, occurrence of the setting error can be detected by providing pull-down resistors with different resistance values on the toner bottle side, instead of the control board side.

### Fourth Exemplary Embodiment

FIG. 7 is a circuit structure illustrating a connection detection device fitted to a control unit in an image forming apparatus according to a fourth exemplary embodiment of the present invention. Components similar to those in FIG. 6 are denoted with same numerals. In FIG. 7, one end of a connection detection signal line 245b is short circuited to the ground on a control board 201 side without resistors. Similarly, one end of a connection detection signal line 255b is short circuited to the ground without resistors.

In a female connector 248, pin sockets 248a and 248b are connected via a resistor R10. Pins 247a and 247b are respectively inserted to the pin sockets 248a and 248b. In a female connector 258, pin sockets 258a and 258b are connected via a resistor R11 having a resistance value different from that of the resistor R10. Pins 257a and 257b are respectively inserted to the pin sockets 258a and 258b.

Therefore, for example, in cases where toner bottles are sequentially set to a connector at a manufacturing process in a factory, it can easily be determined whether the right toner is connected by detecting a detection voltage Vdet according to a resistance value of the toner bottle connected to the connector.

Structures of the connection detection device illustrated in FIGS. 6 and 7 are not limited to toner bottles but similarly applicable to an image forming apparatus that has a plurality of image formation units to determine connection states of respective process cartridges.

A connection between loads and a control board is not always made using electric cables, but the connections can be made by blade springs and coil springs which are provided with conductive wires corresponding to signal lines for connection. The present invention is similarly applicable to these connections.

Although the above-described exemplary embodiments can detect connector connection states on the control board side and the load side, the connector connection state on the load side can be only detected in cases where the harness is directly mounted on the control board. In cases where the harness is directly mounted on the load, the connector connection state only on the control board side can be detected.

Although the above-described exemplary embodiments determine a connector connection state from the detected voltage divided between the power source and the ground, the connector connection state can also be detected from a detected voltage divided between a first potential which is the intermediate between the power source and the ground and a second potential which is higher than the first potential. The connector connection state can be also detected from a detected voltage divided between a negative power source as a first potential and a positive power source as a second potential.

Although the above-described exemplary embodiments illustrate a toner bottle as a cartridge that stores consumables for an image forming apparatus, the connection detection apparatus according to the present invention is not limited to the toner bottles and the aforementioned process cartridges but also applicable to various components as a load.

Furthermore, the connection detection device according to the present invention is not limited to an image forming apparatus but also applicable to various devices.

While the present invention has been described with references to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2007-143847 filed May 30, 2007, which is hereby incorporated by reference herein in its entirety.

What is claimed is:

1. A connection detection device that is mounted on an apparatus including a circuit board having a plurality of connectors and a plurality of load circuits to be connected to the circuit board via each of the plurality of the connectors, the connection detection device detects a connection state between the circuit board and the plurality of the load circuits, the connection detection device comprising:
a plurality of serial connection circuits in which a plurality of pull-down resistors are connected in series with each of connection detection signal lines which is wired to each of predetermined contacts of the plurality of the connectors of the circuit board, wherein each of the plurality of the pull-down resistors has a different resistance value;
a pull-up resistor connected to a parallel connection circuit in which the plurality of serial connection circuits are connected in parallel;
a detection unit configured to detect a voltage value of a connection point between the pull-up resistor and the parallel connection circuit; and
a determination unit configured to determine the connection state between the circuit board and the plurality of the load circuits according to the voltage value detected by the detection unit.

2. The connection detection device according to claim 1, further comprising an information unit configured to inform that an abnormality of the connection state has been determined.

3. The connection detection device according to claim 1, wherein the determination unit determines the connector which causes an improper connection based on the voltage value detected by the detection unit.

4. The connection detection device according to claim 3, wherein the determination unit has a data-table storing data indicating correspondence between the voltage value and the improperly connected connector.

5. The connection detection device according to claim 1, wherein one end of the serial connection circuit is grounded and another end is connected to a power source via the pull-up resistor.

6. The connection detection device according to claim 1, wherein the circuit board and each of the plurality of the load circuits are connected via a harness, wherein the connection detection signal lines are provided within the harness.

7. A connection detection device that is mounted on an apparatus including a circuit board having a plurality of connectors, a plurality of load circuits to be connected to the circuit board via each of the plurality of the connectors, and a plurality of serial connection circuits in which a plurality of pull-down resistors are connected to each of connection detection signal lines which is wired to each of predetermined contacts of the plurality of the connectors on the circuit board, wherein each of the plurality of the pull-down resistors has a different resistance value, the connection detection device which detects a connection state between the circuit board and the plurality of the load circuits, the connection detection device comprising:
a pull-up resistor connected to a parallel connection circuit in which the plurality of serial connection circuits are connected in series, are connected in parallel;
a detection unit configured to detect a voltage value of a connection point between the pull-up resistor and the parallel connection circuit; and
a determination unit configured to determine the connection state between the circuit board and the plurality of the load circuits based on the voltage value detected by the detection unit.

8. The connection detection device according to claim 7, wherein the connection detection device is connected to the circuit board via a connector which is different from the connectors connecting each of the plurality of the load circuits.

9. The connection detection device according to claim 7, wherein the circuit board and each of the plurality of the load circuits is connected via a harness, wherein the connection detection signal lines are provided within the harness.
